(19) United States
(12) Patent Application Publication
(10) Pub. No.: US 2024/0046064 A1
(43) Pub. Date: Feb. 8, 2024

(54) SYSTEM AND METHOD OF SELF-LEARNING FROM AN AUTOMATIC QUERY RESPONSE GENERATOR USING MACHINE LEARNING MODEL

(71) Applicant: RN CHIDAKASHI TECHNOLOGIES PRIVATE LIMITED, Mumbai (IN)

(72) Inventors: Prashant Iyengar, Mumbai (IN); Hardik Godara, Jodhpur (IN)

(21) Appl. No.: 18/282,526

(22) PCT Filed: Mar. 18, 2022
(86) PCT No.: PCT/IN2022/050266

§ 371 Date: Sep. 16, 2023

(30) Foreign Application Priority Data
Mar. 19, 2021 (IN) 202121011816

(51) Int. Cl. G06N 3/006; G06N 5/022

(52) U.S. Cl. CPC G06N 3/006; G06N 5/022

(57) ABSTRACT

A multi-echelon self-learning system and a method for automatically generating a response for input query from data storage systems based on ranking of keywords using machine learning (ML) model is provided. The method includes obtaining the input query from an input robot through input peripheral associated with a user. The method includes validating the input query with child safety constraints to determine child safety of the input query. The method includes processing the child safe input query to determine top-ranked keywords. The method includes determining appropriate keyword from top-ranked keywords based on relevance of intention of the input query. The method includes enabling interactive conversation between the user and the input robot by determining the response for the input query based on appropriate keyword from the data storage systems and transmitting, response to output peripheral of the input robot.

### BACKGROUND

### Technical Field

The embodiments herein generally relate to a self-learning query framework, more particularly, a system and method for self-learning and automatically generating a response from one or more data storage systems for an input query based on a ranking of one or more keywords using a machine learning model.

### Description of the Related Art

For an information retrieval or a language-based search, there exist various traditional methods that help in finding and retrieving appropriate data from a database where a large amount of data is stored. The data retrieval may be efficient for the input search query having a specific pattern and structure. But the process is time-consuming and complex, as the input search query needs to be searched within a large amount of data in the database. Further, new input search queries may be provided to a system for which there may be no data existing in the database which is relevant to the new input search queries. Hence, traditional methods are unable to provide an appropriate response to the new input search queries.

Usually, traditional methods involve discarding the data associated with the new input search queries, even though a similar set of input queries may have an appropriate response in the unstructured database provided to the system. Traditional methods also fail to retrieve the best appropriate data for new input search queries which may not have any specific pattern or structure. Some existing systems that handle new input search queries need to be manually updated with query response information for new input search queries.

Accordingly, there remains a need for a system and method of query framework that does not discard the data associated with new input search queries and provide appropriate reactions/responses based on the new input search queries. The new input query acceptance range also needs to be increased.

### SUMMARY

In view of foregoing an embodiment herein provides a processor-implemented method for automatically generating a response for an input query from one or more data storage systems based on a ranking of one or more keywords using a machine learning (ML) model. The method includes obtaining the input query from an input robot through an input peripheral associated with a user. The method includes determining whether the input query is child safe by interpreting the input query, and validating the input query with a set of child safety constraints. The method includes processing, using structured data processing, the input query that is child safe to determine top-ranked keywords. The top-ranked keywords are determined by, (i) determining, using an entity detection technique, an entity/domain for the input query by detecting a context of the input query; (ii) categorizing, using a query categorization technique, the input query into one or more keywords based on the entity/domain and the context; and (iii) determining, using an entity and joint query entity detection module, the top-ranked keywords based on confidence scores of the one or more keywords, the confidence scores of the one or more keywords are determined using speech recognition alternative methods. The method includes determining, using a query resolution technique and a word sense disambiguation method, an appropriate keyword from the top-ranked keywords based on a relevance of an intention of the input query, the query resolution technique, and the word sense disambiguation method are performed by defining the input query such that to match with the intention of the input query less ambiguously. The method includes enabling an interactive conversation between the user and the input robot that matches the intention of the user by determining and generating, using a trained ML model, the response for the input query based on the appropriate keyword from the data storage systems and transmitting, the response for the input query to an output peripheral of the input robot.

In some embodiments, the set of child-safe constraints is stored in the data storage systems.

In some embodiments, the method includes verifying, using a lower-class structured data processing technique, the response with the set of child safety constraints before transmitting the response for the input query to the output peripheral of the input robot, if the response matches with the set of child safety constraints, then the response is child safe and if the response does not match with the set of child safety constraints then the response is not child safe.

In some embodiments, the method includes training the ML model by correlating a set of historical input queries with a set of historical responses to obtain the trained ML model.

In some embodiments, the method includes retraining the ML model if there is a misalignment between the response and a predicted response for the input query by providing the response to the ML model.

In some embodiments, the method includes classifying the input query to retrain the ML model if the input query does not satisfy the set of child safety constraints.

In some embodiments, the method includes classifying the input query to retrain the ML model if the input query does not have a domain and does not categorize into the one or more keywords.

In some embodiments, the method includes converting an unstructured input query into a structured query by dividing the unstructured input query into at least one paragraph or sentence to detect a sentence with the structured query. In some embodiments the structured query includes the input query.

In some embodiments, the structured data processing includes entity detection technique, query categorization technique, joint entity detection technique.

In one aspect, one or more non-transitory computer-readable storage medium store the one or more sequence of instructions, which when executed by a processor, further causes a method for automatically generating a response for an input query from one or more data storage systems based on a ranking of one or more keywords using a machine learning (ML) model. The method includes obtaining the input query from an input robot through an input peripheral associated with a user. The method includes determining whether the input query is child safe by interpreting the input query, and validating the input query with a set of child safety constraints. The method includes processing, using structured data processing, the input query that is child safe to determine top-ranked keywords. The top-ranked keywords are determined by, (i) determining, using an entity detection technique, an entity/domain for the input query by detecting a context of the input query; (ii) categorizing, using a query categorization technique, the input query into one or more keywords based on the entity/domain and the context; and (iii) determining, using an entity and joint query entity detection module, the top-ranked keywords based on confidence scores of the one or more keywords, the confidence scores of the one or more keywords are determined using speech recognition alternative methods. The method includes determining, using a query resolution technique and a word sense disambiguation method, an appropriate keyword from the top-ranked keywords based on a relevance of an intention of the input query, the query resolution technique, and the word sense disambiguation method are performed by defining the input query such that to match with the intention of the input query less ambiguously. The method includes enabling an interactive conversation between the user and the input robot that matches the intention of the user by determining and generating, using a trained ML model, the response for the input query based on the appropriate keyword from the data storage systems and transmitting, the response for the input query to an output peripheral of the input robot.

In another aspect, a multi-echelon system for automatically generating a response for an input query from one or more data storage systems based on a ranking of one or more keywords using a machine learning (ML) model is provided. The system includes an input robot that is associated with a user includes at least one an input peripheral or an output peripheral that obtains the input query from the user. The system includes a self-learning server, acquire the input query from the input robot and process the input query using the machine learning model includes a memory unit that stores a database and a set of modules, and a processor that is configured to execute the set of instructions and is configured to (i) determine whether the input query is child safe by interpreting the input query, and validating the input query with a set of child safety constraints; (ii) process, using structured data processing, the input query that is child safe to determine top ranked keywords, the determination of the top ranked keywords includes, (a) determine, using an entity detection technique, an entity/domain for the input query by detecting a context of the input query; (b) categorize, using a query categorization technique, the input query into one or more keywords based on the entity/domain and the context; and (c) determine, using an entity and joint query entity detection module, the top ranked keywords based on confidence scores of the one or more keywords, the confidence scores of the one or more keywords are determined using speech recognition alternative methods; (iii) determine, using a query resolution technique and a word sense disambiguation method, an appropriate keyword from the top-ranked keywords based on a relevance of an intention of the input query, and (iv) enable an interactive conversation between the user and the input robot that matches the intention of the user by determining and generating using a trained ML model, the response for the input query from the data storage systems and transmit, the response for the input query to an output peripheral of the input robot. In some embodiments, the query resolution technique and the word sense disambiguation method are performed by defining the input query such that it matches with the intention of the input query less ambiguously.

In some embodiments, the set of child-safe constraints is stored in the data storage systems.

In some embodiments, the method includes verifying, using a lower-class structured data processing technique, the response with the set of child safety constraints before transmitting the response for the input query to the output peripheral of the input robot, if the response matches with the set of child safety constraints, then the response is child safe and if the response does not match with the set of child safety constraints then the response is not child safe.

In some embodiments, the method includes training the ML model by correlating a set of historical input queries with a set of historical responses to obtain the trained ML model.

In some embodiments, the method includes retraining the ML model if there is a misalignment between the response and a predicted response for the input query by providing the response to the ML model.

In some embodiments, the method includes classifying the input query to retrain the ML model if the input query does not satisfy the set of child safety constraints.

In some embodiments, the method includes classifying the input query to retrain the ML model if the input query does not have a domain and does not categorize into the one or more keywords.

In some embodiments, the method includes converting an unstructured input query into a structured query by dividing the unstructured input query into at least one paragraph or sentence to detect a sentence with the structured query. In some embodiments the structured query includes the input query.

In some embodiments, the structured data processing includes entity detection technique, query categorization technique, joint entity detection technique.

The self-learning multi-echelon query framework results in the ability of the system to function using low-cost hardware. Unstructured data processing modules require significantly higher computational resources than structured data processing modules. The multi-echelon system consisting of multiple classes of self-learning leads to structured modules continuously being trained using higher-classes in case of no reaction/responses to queries thereby leading to accurate, computationally faster, lower-class systems dependent on structured systems which thereby reduces cost and increases speed thereby leading to the usage of these systems in application areas of robots in homes other consumer segments. In some embodiments, responses from unstructured databases are used to repopulate structured databases. In some embodiments, self-learning carried out over N days is used to retrain the entire system. The self-learning for input query by a particular user is used to provide reaction/responses to other users. In some embodiments, non-reaction/response to input query by users reduces.

The multi-echelon system provides reaction/responses for user-initiated query and the system promotes fast reaction/responses. The system is enhanced with a multi-echelon learning framework. The lower classes of the self-learning query framework are used initially to extract reaction/responses for input queries. These classes use structured AI modules which work faster followed by unstructured AI modules in case of no reaction/response by structured modules. The categorized query and domain/entity are searched using structured or unstructured databases and appropriate reaction/responses are provided to the user. The lower classes of the self-learning framework provide fast real-time responses. When reaction/responses from lower-class structured AI modules are not available to the user, this multi-echelon system moves on to higher-classes of the query framework. The higher-classes provide high accuracy non-real-time reaction/responses. The higher classes of the self-learning framework use structured and unstructured AI modules used for query categorization and domain/intent detection. The categorized query and entity/domain are searched using structured/unstructured databases and appropriate reaction/responses are provided to the user. The user is updated with the reaction/responses of the non-real-time high accuracy classes in active conversation. When reaction/responses from higher classes are not available the agent query framework is used. Unknown queries after processing using lower-class query framework and higher-classes of query framework are addressed manually using agent query framework. The higher-classes are non-real-time but provide accurate reactions/responses. The lower classes of the self-learning query framework are faster and provide real-time reaction/responses. In some embodiments, their accuracy rates are lesser. This self-learning query framework is enabled with the process of training lower-class algorithms with results from higher-class high accuracy systems. In some embodiments, over a period of time the lower-classes of systems exhibit accuracy and speed. The data derived from unstructured databases are repopulated to structured databases making the system reaction/response to input query faster over a period of time.

Every answered query is stored, updated to internal memory and cache memory this allows the system to respond faster and is trained to a data processing to save time while processing the same query. The system captures input queries irrespective of whether reaction/responses for queries are available or not and every query keyword is passed through the hierarchy of the system, and this reduces the response delay time. The system obtains responses and updates the databases globally, for the queries logged into the analytics module, within a very short time, this helps the system to use a database for global improvement with fast response.

The multi-echelon system retrieves responses for all types of keywords due to the involvement of the self-learning query framework. The rate of retrieval is faster due to the multi-layer architecture. Hence, the delay in the retrieval of responses is drastically reduced. Moreover, the self-learning query framework balances the trade-off between computing resources and speed.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a multi-echelon self-learning system for automatically generating a response for an input query from one or more data storage systems based on a ranking of one or more keywords using a machine learning (ML) model according to some embodiments herein;

FIG. 2 illustrates a block diagram of a self-learning server of FIG. 1 according to some embodiments herein;

FIG. 3A illustrates a block diagram of a pre-processing module if the input query is unstructured according to some embodiments herein;

FIG. 3B illustrates an exemplary view of generating a response for an unstructured input query from one or more data storage systems based on a ranking of one or more keywords using an ML model according to some embodiments herein;

FIG. 4 illustrates an exemplary view of training ML model of FIG. 2 according to some embodiments herein;

FIG. 5 illustrates a block diagram of a structured data processing module of FIG. 2 according to some embodiments herein;

FIG. 6 is an exemplary view of the training flow of the databases using machine learning model according to some embodiments herein; FIGS. 7A-7B are flow diagrams that illustrate a method of automatically generating a response for an input query from one or more data storage systems based on ranking of one or more keywords using a machine learning (ML) model according to some embodiments herein; and

FIG. 8 is a schematic diagram of the computer architecture of a self-learning server in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

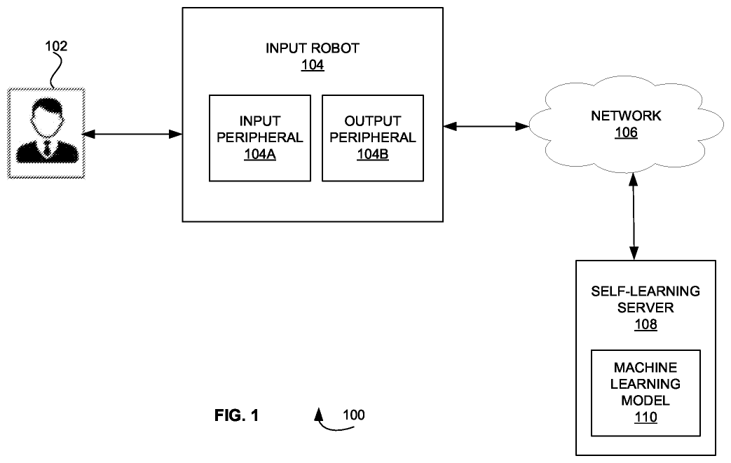

As mentioned, there remains a need for a system and method for potential and efficient methods of self-learning-based search engines with a wide range of input query acceptance. The embodiment herein achieves this by training data processing models and knowledge databases using the machine learning model. Referring now to the drawings and more particularly through FIG. 1 to FIG. 8, where similar reference characters denote corresponding features consistently throughout the figures, preferred embodiments are shown.

FIG. 1 is the block diagram of a multi-echelon self-learning system 100 for automatically generating a response for an input query from one or more data storage systems based on a ranking of one or more keywords using a machine learning (ML) model 110 according to some embodiments herein. The multi-echelon self-learning system 100 includes an input robot 104 that is accessed by a user 102, and a self-learning server 108 that includes the machine learning model 110. The input robot 104 includes an input peripheral 104A, and an output peripheral 104B. The input peripheral 104A and the output peripheral 104B without limitation, are selected from a touch screen, a keyboard, a microphone, a camera, a mouse, a magnetic ink character reader (MICR), a scanner, or a joystick.

The self-learning server 108 obtains the input query from the input robot 104 through the input peripheral 104A associated with the user 102 through a network 106. In some embodiments, the network 106 is a wired network or a wireless network. In some embodiments, the network 106 is a combination of a wired and wireless network. In some embodiments, the network 106 is the Internet.

The input query from the user 102 may include at least one of an unstructured input query or a structured input query. The self-learning server 108 validates the input query with a set of child safety constraints to determine whether the input query is child-safe or not. In some embodiments, if the input query matches with the child safety constraints, then the self-learning server 108 processes the input query. For example, if the input query is “what is the weather in Mumbai”, then the input query matches with the child safety constraints to process the input query further. In some embodiments, if the input query does not match with the child safety constraints, then the self-learning server 108 provides a recorded fall-back reaction/response and logs the input query into analytics to train the machine learning model 110 for self-learning purposes. For example, if the input query is “how to make an explosive device”, then the input query does not match with the child safety constraints to provide a recorded fall-back reaction/response and logs the input query. In some embodiments, the set of child safe constraints are when the input query falls under at least one of misleading family content, harmful or dangerous acts involving minor users or users with emotional distress, infliction of emotional distress on minor users, harassing minor users and the like.

The self-learning server 108 processes the input query that is child-safe to determine top-ranked keywords using structured data processing. The self-learning server 108 determines an entity/domain for the input query by detecting a context using an entity detection technique. In some embodiments, the entity detection technique automatically identifies named entities in the input query and classifies the input query into predefined categories. The entity detection technique may detect a word, or string of words that form the entity. The entity may be a person names, geographic locations, organizations, product names, monetary values, percentages, quantities, names of events, dates and times, amounts of money, etc. The entity detection technique may detect the entity/domain to a word from the input query by deriving the meaning of the word from the input query.

For example, if the input query is “what is the weather in Mumbai”, then the entity/domain that is detected is Mumbai. The entity/domain that is detected for Mumbai may be a location. The entity/domain may be retrieved from a functional database. The functional database maybe, but is not limited to, an internal database, an internal API's/service, an external database, an external API's/service, or an in-memory database. In some embodiments, the entity/domain for the input query may not be found and a recorded fall-back reaction/response is sent to the user 102 by the self-learning server 108 and the input query is logged into an analytics module to train the machine learning model 110 for self-learning purpose. When the entity is invalid, a recorded fall-back reaction/response is sent to the user 102 and the input query is logged into the analytics module to train the machine learning model 110 for self-learning purposes. In some embodiments, the entity may be found but data associated with the entity may not be found. When the entity may be found but data associated with the entity may not be found, then a recorded fall-back reaction/response is sent to the user 102 by the self-learning server 108 and the input query is logged into the analytics module to train the machine learning model 110 for self-learning purpose.

The self-learning server 108 categorizes the input query into one or more keywords based on the entity/domain and the context using a query categorization technique. The query categorization method may categorize one or more keywords to their respective detected entities/domains. For example, if the input query is “what is the weather in Mumbai”, then the input query is categorized into weather for the detected entity Mumbai. For example, the word “Mumbai” is categorized to the entity location. In some embodiments, the one or more keywords may not be categorized, and a recorded fall-back reaction/response is provided through the output peripheral 104B to the user 102 and the input query is logged into the analytics module to train the machine learning model 110 for self-learning purposes. In some embodiments, the analytics module run in the background to obtain the expected reaction.

The self-learning server 108 determines the top-ranked keywords based on confidence scores of the one or more keywords using an entity and joint query entity detection module. The confidence scores of the one or more keywords are determined using speech recognition alternative methods. In some embodiments, the self-learning server 108 performs the entity detection technique, the query categorization technique, and an entity and joint query entity detection module concurrently. In some embodiments, the confidence score indicates how certain the speech recognition alternative methods are the respective intent is correctly assigned. The confidence score may have a value between 0 and 1. For example, for an intent “burger order”, four phrases are stored in the database as “burger order”, “order burger”, “I would like to place an order for a burger”, “I want to order a burger”. When the input query matches with the intention, “I would like to order a burger from you”, then the confidence score is 0.8. In some embodiments, the speech recognition alternative methods are vector quantization model, dynamic time warping model, and artificial neural network model.

The self-learning server 108 determines an appropriate keyword from the top-ranked keywords based on a relevance of an intention of the input query. The self-learning server 108 performs query resolution and word sense disambiguation method by defining the input query such that to match the top-ranked keywords with the intention of the input query less ambiguously. In some embodiments, the word sense disambiguation method determines which meaning of keyword is activated by the use of keyword in a particular context. The word sense disambiguation method is used for machine translation in different senses. The self-learning server 108 determines the response for the input query based on the appropriate keyword from the one or more data storage systems. The self-learning server 108 transmits, the response for the input query to the output peripheral 104B of the input robot 104. The self-learning server 108 enables an interactive conversation between the user 102 and the input robot 104 that matches the intention of the user 102 using the transmitted response for the input query to the output peripheral 104B of the input robot 104.

If the appropriate reactions/responses may not be found, a recorded fall-back reaction/response may be sent to the user 102 along with logging the input query into the analytics module to train the machine learning model 110 for self-learning purposes.

A self-learning multi-echelon query framework results in the ability of the multi-echelon system to function using cost-effective hardware. An unstructured data processing module requires significantly higher computational resources than structured data processing modules. The multi-echelon system includes multiple classes of self-learning leads to structured modules continuously being trained using higher classes in case of no reactions to queries thereby leading to accurate, computationally faster, lower-class systems dependent on structured systems which thereby reduces cost and increases speed thereby leading to the usage of these systems in application areas of robots in homes another consumer segment.

In some embodiments, the input query may not be in the base language. In some embodiments, the self-learning query framework is applied for multiple languages. In some embodiments, each language may have a self-learning query framework with a multi-echelon data processing module and a database corresponding to each language. In some embodiments, the input query may be in any language selected by the user that is different from the base language. The input query in a selected language is translated to a base language and fed to the self-learning server 108. The input query in a selected language is stored in databases in selected languages. Similarly, the reaction/responses obtained are translated to the selected language. Such systems reduce computational time and improve accuracy for multiple languages over a short period.

In some embodiments, the multi-echelon data processing module of the self-learning query frameworks, the lower-class unstructured data processing systems of a multi-echelon system are language-dependent, and the non-real-time higher-class high accuracy data processing systems function independently irrespective of language. The lower-class unstructured data processing systems of the multi-echelon system represent the input query in a mathematical representation and transfer to the non-real-time higher-class high accuracy data processing systems. In some embodiments, the self-learning server 108 converts the input queries to the text which is then converted into a mathematical representation. The self-learning server 108 interprets the mathematical representation using the non-real-time higher-class high accuracy data processing module of the multi-echelon system irrespective of the language.

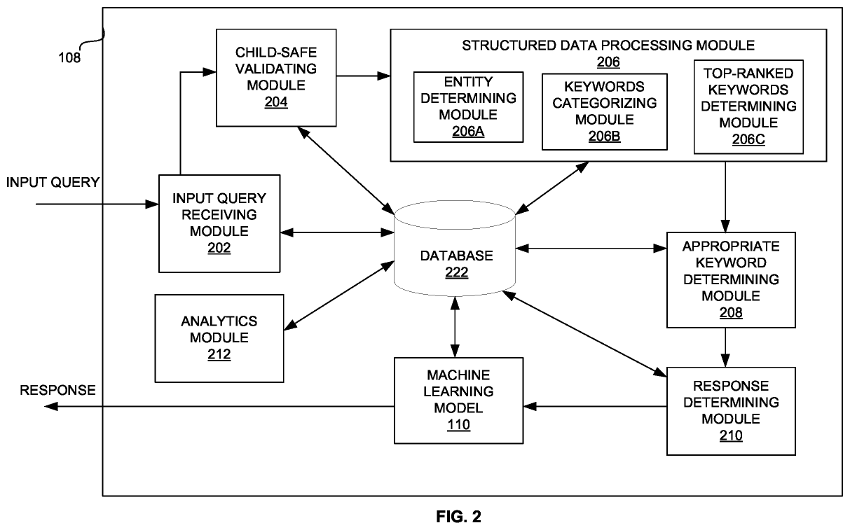

FIG. 2 illustrates a block diagram of the self-learning server 108 of FIG. 1 according to some embodiments herein. The self-learning server 108 includes an input query receiving module 202, a child-safe validating module 204, a structured data processing module 206, an entity determining module 206A, a keywords categorizing module 206B, a top-ranked keywords determining module 206C, an appropriate keyword determining module 208, a response determining module 210, the machine learning model 110, a database 222 and an analytics module 212.

The input query receiving module 202 receives the input query from the input robot 104 through the input peripheral 104A associated with the user 102. The query child safe module 204 validates the input query with a set of child safety constraints to determine whether the input query is child safe. For example, if the input query is “what is the weather in Mumbai”, then the input query matches with the child safety constraints to process the input query further. In some embodiments, if the input query given by the user 102 does not satisfy the child safety constraints, then a recorded fall-back reaction/response is provided through the output peripheral 104B and logs the input query into the analytics module 212 for self-learning of the machine learning model 110. In some embodiments, the set of child safe constraints are when the input query falls under at least one of misleading family content, harmful or dangerous acts involving minor users or users with emotional distress, infliction of emotional distress on minor users, harassing minor users and the like. For example, if the input query is “how to make an explosive device”, then the input query does not match with the child safety constraints to provide a recorded fall-back reaction/response and logs the input query. As the input query falls under harmful or dangerous acts, the child safety constraints are not satisfied to process the input query further.

In some embodiments, the analytics module 212 may run in the background to obtain the expected reaction/response. The structured data processing module 206 processes the input query that is child-safe to determine top-ranked keywords using the structured data processing. In some embodiments, structured data is when data is in a standardized format, has a well-defined structure, compiles to a data model, follows a persistent order, and is easily accessible. The processing of the structured data maybe called as structured data processing.

The entity determining module 206A determines an entity/domain for the input query by detecting a context of the input query using an entity detection technique. For example, if the input query is “what is the weather in Mumbai”, then the entity/domain that is detected is Mumbai. The keywords categorizing module 206B categorizes the input query into one or more keywords based on the entity/domain and the context using a query categorization technique. For example, if the input query is “what is the weather in Mumbai”, then the input query is categorized into weather for the detected entity Mumbai. In some embodiments, the keywords may not be categorized, and a recorded fall-back reaction/response is provided through the output peripheral 104B, and the input query is logged into the analytics module 212 for self-learning of the machine learning model 110. In some embodiments, the analytics module 212 may run in the background to obtain the expected reaction/response.

In some embodiments, the entity may not be found, and a recorded fall-back reaction/response is provided through the output peripheral 104B, and the input query is logged into the analytics module 212 for self-learning of the machine learning model 110. In some embodiments, the entity may be invalid, a recorded fall-back reaction/response is provided, and the input query is logged into the analytics module 212 for self-learning of the machine learning model 110. In some embodiments, the entity may be found but data associated with the entity may not be found and a recorded fall-back reaction/response is provided through the output peripheral 104B and the input query is logged into the analytics module 212 for self-learning of a machine learning model 110 utilizing lower class unstructured data processing or higher-class structured processing or higher-class unstructured processing.

The top-ranked keywords determining module 206C determines the top-ranked keywords based on confidence scores of the one or more keywords using an entity and joint query entity detection module. The confidence scores of the one or more keywords are determined using speech recognition alternative methods

The appropriate keyword determining module 208 determines an appropriate keyword from the top-ranked keywords based on a relevance of an intention of the input query. The appropriate keyword determining module 208 performs query resolution and word sense disambiguation method by defining the input query such that to match the top-ranked keywords with the intention of the input query less ambiguously. The response determining module 210 determines the response for the input query based on the appropriate keyword from the data storage systems. The interactive conversation enabling module 210 enables an interactive conversation between the user 102 and the input robot 104 that matches the intention of the user 102 by transmitting, the response for the input query to the output peripheral 104B of the input robot 104 that.

In some embodiments, the data storage systems maybe, but are not limited to, an internal database, an internal API's/service, an external database, an external API's/service, and an in-memory database. In some embodiments, appropriate reaction/responses may not be found, and a recorded fall-back reaction/response may be sent to the user 102 through the output peripheral 104B along with logging the input query into the analytics module 212 for self-learning of the machine learning model 110.

The database 222 stores data of entities/domains and categories of queries. In some embodiments, the database may be but is not limited to in-memory, external and internal databases. The analytics module 212 stores all the failure input query keywords along with an associated reason which enables the machine learning model 110 to self-learn and train from logged data.

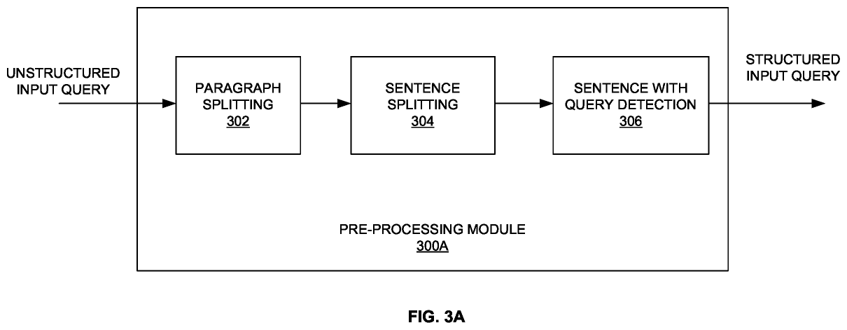

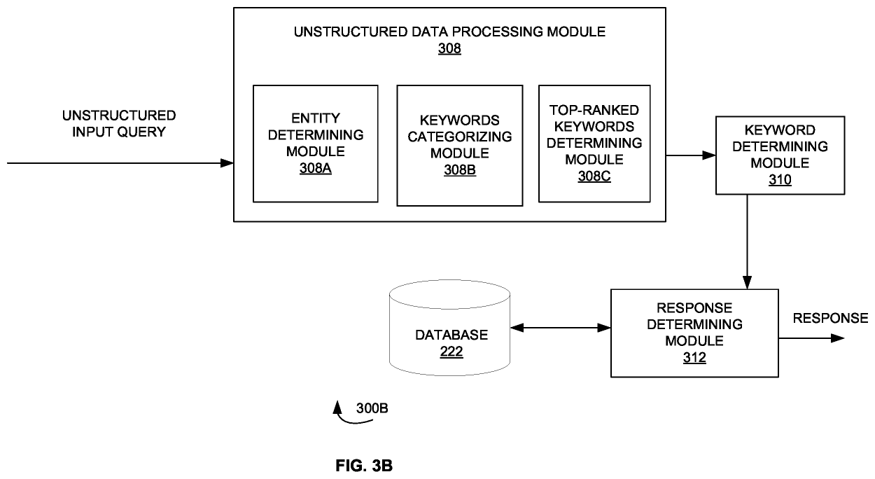

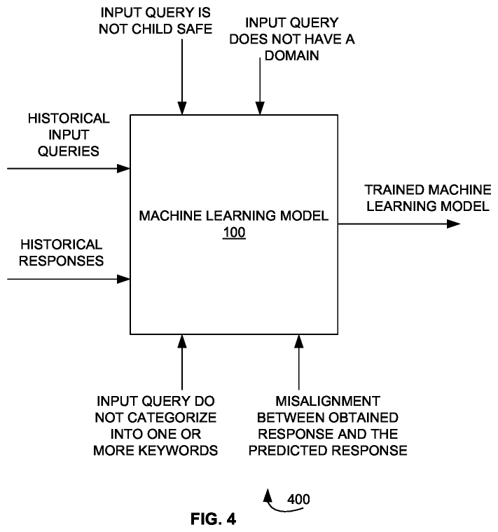

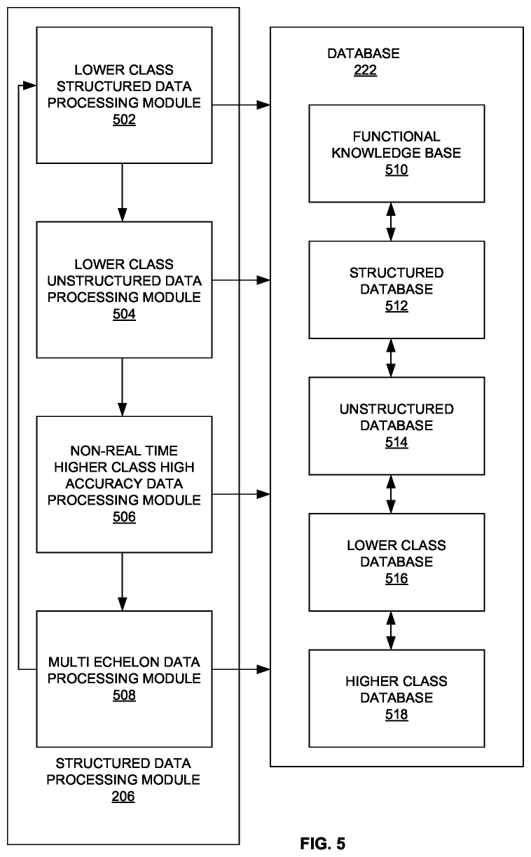

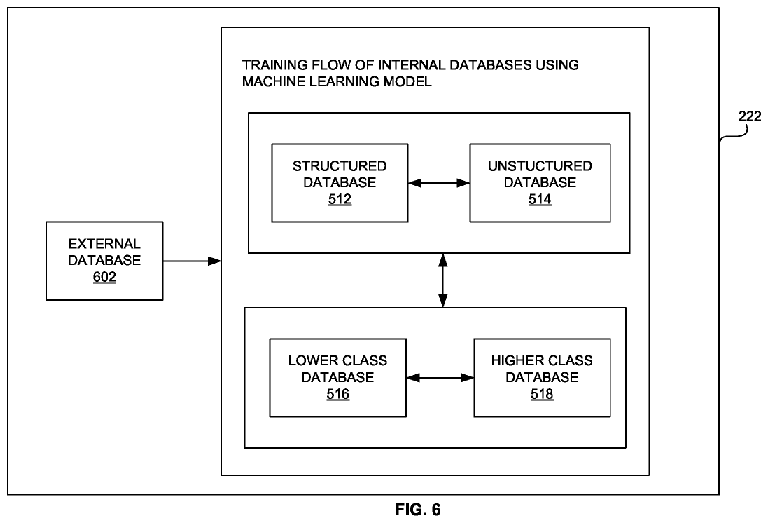

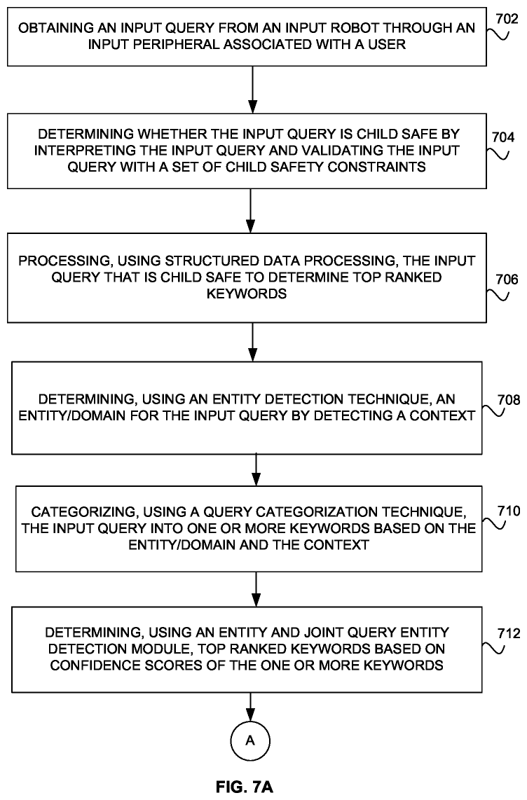

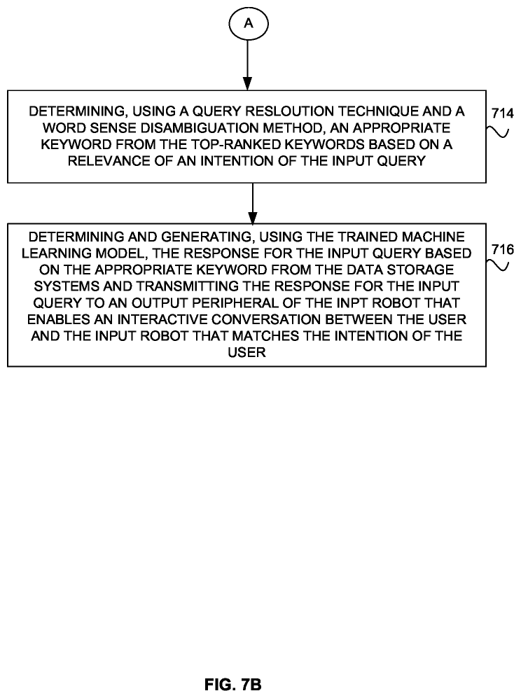

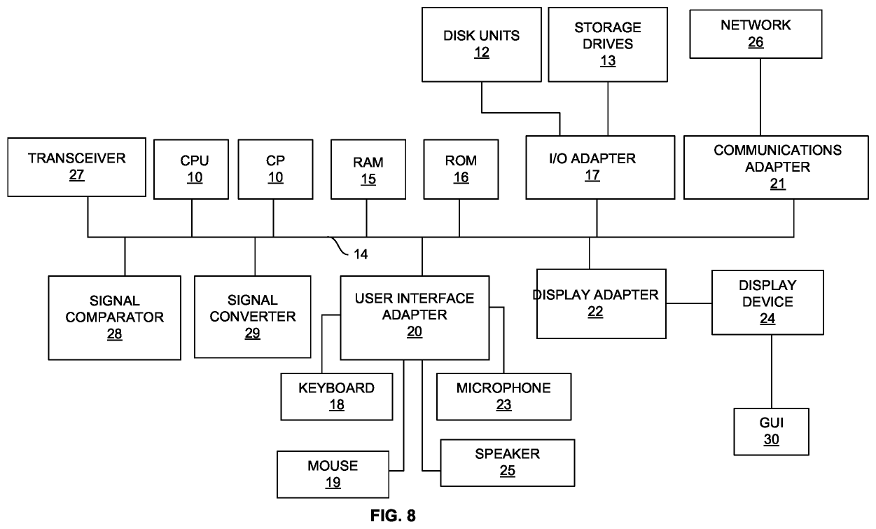

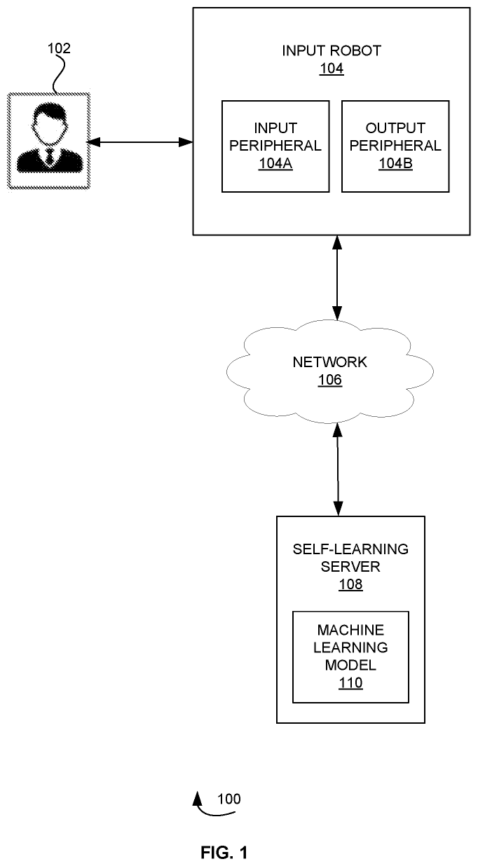

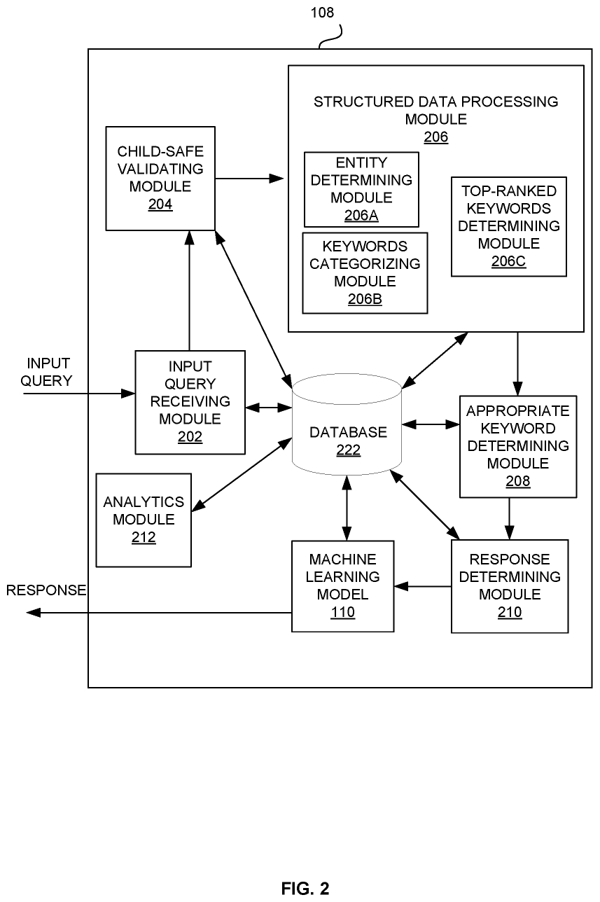

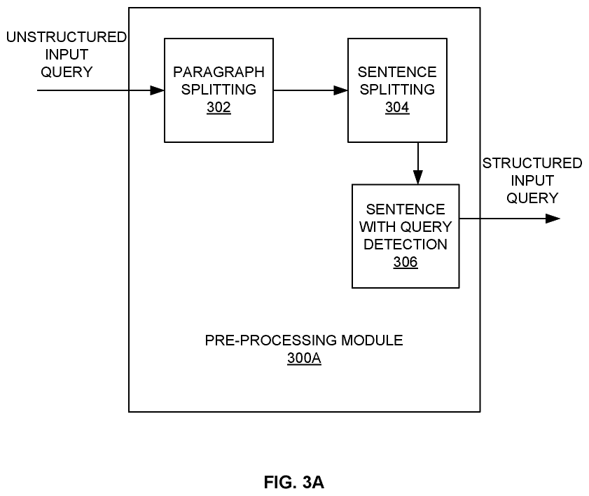

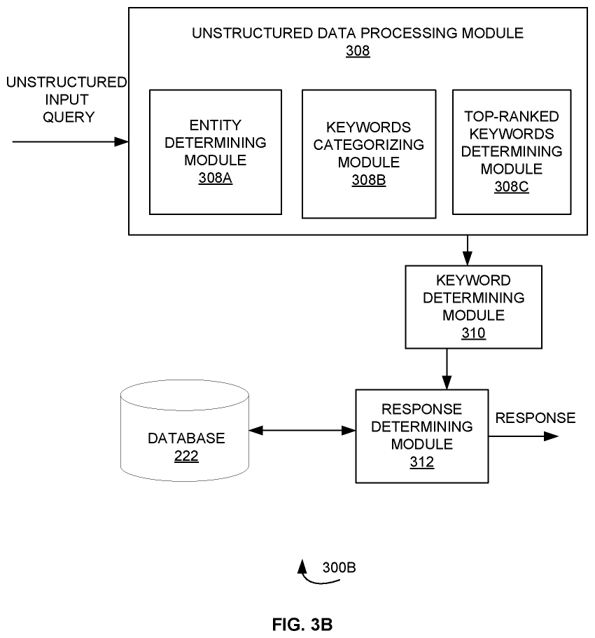

FIG. 3A illustrates a block diagram 300A of a pre-processing module if the input query is unstructured according to some embodiments herein. The block diagram 300A of the pre-processing module includes a paragraph splitting module 302, a sentence splitting module 304, a sentence detection module 306. The pre-processing module converts an unstructured input query into a structured input query and detects the entity/domain of the input query. The structured input query may be, for example, “what is the weather in Mumbai”, “List out the flights to Chennai from Hyderabad on 10 Feb. 2022”, “what is the cricket score in today's match”, etc. The pre-processing is performed to detect an entity/domain or to categorize the unstructured input query from the unstructured database. The paragraph splitting 302 splits the unstructured input query into paragraphs. The structured input query may be, for example, “sports playing”, “songs western”, etc. The sentence splitting 304 splits the paragraphs into sentences. The sentence with query detection 306 detects the entity/domain matching with the unstructured input query.

FIG. 3B illustrates an exemplary view 300B of generating a response for an unstructured input query from one or more data storage systems based on a ranking of one or more keywords using the machine learning model 110 according to some embodiments herein. The exemplary view 300B includes receiving an unstructured input query by an unstructured data processing module 308 for processing. The unstructured data processing module 308 may segment the unstructured input query. The unstructured data processing module 308 includes an entity determining module 308A, a keywords categorizing module 308B, and a top-ranked keywords determining module 308C. The entity determining module 308A determines an entity/domain for the unstructured input query by detecting a context of the unstructured input query using an entity detection technique. In some embodiments, the entity/domain may not be found or the entity/domain may be invalid or the entity/domain may be found but data may not be found using unstructured data processing. In some embodiments, the unstructured input queries undergo lower-class unstructured data processing. The keywords categorizing module 308B categorizes the unstructured input query into one or more keywords based on the entity/domain and the context using an unstructured query categorization technique.

In some embodiments, the unstructured data processing module 308 performs the entity detection technique, the unstructured query categorization technique, and the entity and joint query entity detection module concurrently.

The top-ranked keywords determining module 308C determines an appropriate keyword from the top-ranked keywords based on a relevance of an intention of the unstructured input query. The keywords determining module 310 performs unstructured query resolution and unstructured word sense disambiguation method by defining the unstructured input query such that to match the top-ranked keywords with the intention of the unstructured input query less ambiguously. In some embodiments, the reaction/response for the unstructured input query may not be found in the retrieved responses, then the recorded fall-back reaction/response is given, and the unstructured input query is logged into the analytics module 212 for the manual answer of that query. In some embodiments, logging of data may be attached with the reason of failure for self-learning machine learning algorithms for higher accuracy non-real-time segmentation.

The response determining module 312 determines the response for the unstructured input query based on the appropriate keyword from the database 222. The interactive conversation enabling module 312 enables an interactive conversation between the user 102 and the input robot 104 that matches the intention of the user 102 by transmitting, the response for the unstructured input query to the output peripheral 104B of the input robot 104.

In some embodiments, the reaction/response for the unstructured input query may not be found in the retrieved reaction/response after processing the lower-class structured data processing or the lower-class unstructured data processing modules. When the reaction/response for the input query may not be found in the retrieved reaction/response after processing then the query is logged into the analytics module 212 to provide the manual reaction/response to that query. In some embodiments, logging analytics may also include the reason for failure for self-learning machine learning algorithms for higher accuracy of non-real-time segmentation. The database 222 stores the obtained top-ranked reaction/responses in a cache memory. The self-learning server 108 shares the cache memory with the machine learning model 110, a structured data processing module, an unstructured data processing module 308, a structured database, and an unstructured database.

In some embodiments, when the logged analytics for the unstructured input query by processing in lower-class structured and unstructured data processing modules do not have any reaction/responses using non-real-time high accuracy data processing modules then the reaction/responses obtained are updated to the user 102, in the active conversations through the input robot 104 associated with the user 102. In some embodiments, the non-real-time higher-class high accuracy data processing modules includes a self-learning query framework for both structured and unstructured input query.

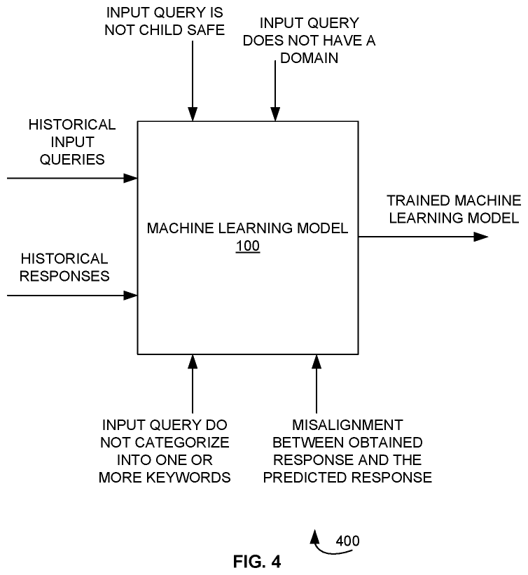

FIG. 4 illustrates an exemplary view 400 of training the ML model 110 of FIG. 2 according to some embodiments herein. The exemplary view 400 includes training the ML model 110 by correlating a set of historical input queries with a set of historical responses to obtain the trained ML model. For example, the set of historical input queries may be “what is the weather in Mumbai”, “List out the flights to Chennai from Hyderabad on 10 Feb. 2022”, “what is the cricket score in today's match”, etc. and the set of historical responses may be “partly cloudy with temperature 23° Celsius”, “A-321 at 14:30 PM via Bangalore, A-320 at 6:54 am non-stop”, “120 runs for no loss” etc. The exemplary view 400 includes retraining the ML model 110 if there is a misalignment between the response and a predicted response for the input query by responding to the ML model 110. The exemplary view 400 retraining the ML model 110 if the input query does not satisfy the set of child safety constraints by classifying the input query. The exemplary view 400 retraining the ML model 110 if the input query does not have a domain and does not categorize into the one or more keywords by classifying the input query.

In some embodiments, the reaction/responses from the user review are used to train higher-class high accuracy systems. In some embodiments, the reaction/responses from non-real-time higher-class high accuracy data processing systems are used to train the lower-class unstructured data processing system. In some embodiments, the reaction/responses from unstructured data processing modules are used to train structured data processing modules. In some embodiments, data from structured data processing modules are used to train unstructured data processing modules.

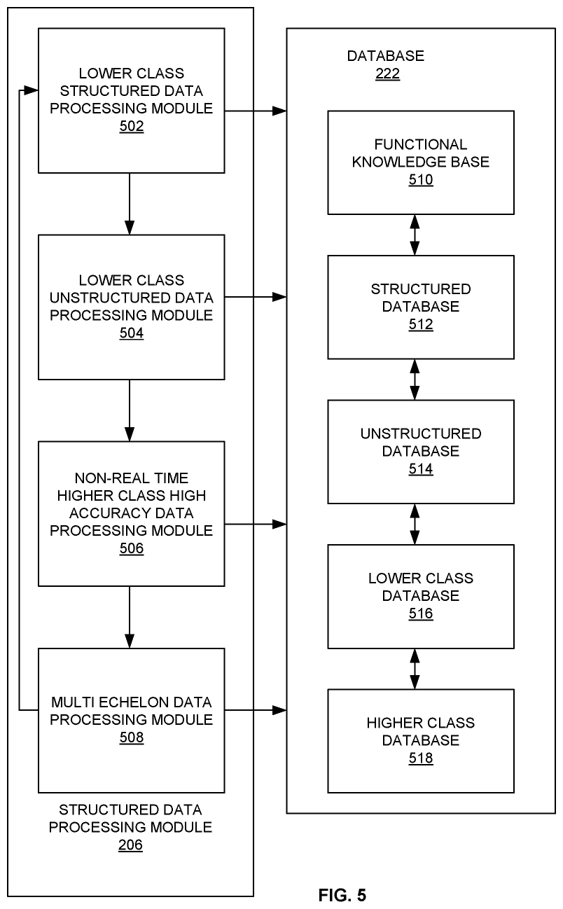

FIG. 5 illustrates a block diagram of the structured data processing module 206 of FIG. 2 according to some embodiments herein. The structured data processing module 206 includes a lower-class structured data processing module 502, a lower-class unstructured data processing module 504, a non-real-time higher-class high accuracy data processing module 506, a multi-echelon data processing module 508, a functional database 510, a structured database 512, an unstructured database 514, a lower-class database 516 and a higher-class database 518. The lower-class structured data processing module 502 processes the input query given by the user 102, where the input query is structured. In some embodiments, the lower-class structured data processing module 502 retrieves the reaction/response to the input query from the lower-class database 516 and structured database 512, using the machine learning model 110. The lower-class unstructured data processing module 404 processes the input query given by the user 102, where the input query is unstructured. In some embodiments, the lower-class unstructured data processing module 504 retrieves the reaction/response to the input query from the lower-class database 516 and unstructured database 514, using the machine learning model 110.

The non-real-time higher-class data processing module 506 processes the input query given by the user if the reaction/response to the input query is not obtained using either the lower-class structured data processing module 502 or unstructured data processing module 504. In some embodiments, the non-real-time higher-class data processing module 506 retrieves the reaction/response to the input query from the higher-class database 518, using the machine learning model 110. The multi-echelon data processing module 508 processes the input query given by the user 102, where the input query is in a different language other than the base language. In some embodiments, the multi-echelon data processing module 408 may perform the whole self-learning query framework after translating the input query in the user language to the base language of the self-learning server 108.

In some embodiments, the lower-class unstructured data processing module 504 and the lower-class structured data processing module 502 of the multi-echelon self-learning framework are language dependent and the non-real-time higher-class high accuracy data processing module 506 function independent and is irrespective of language. The lower-class structured data processing 502 and lower-class unstructured data processing module 504 of the multi-echelon data processing module 508 represents the input query in a mathematical representation and transfer to the non-real-time higher-class high accuracy data processing systems. The self-learning server 108 interprets the mathematical expression using the non-real-time higher-class high accuracy data processing module of the multi-echelon system irrespective of language.

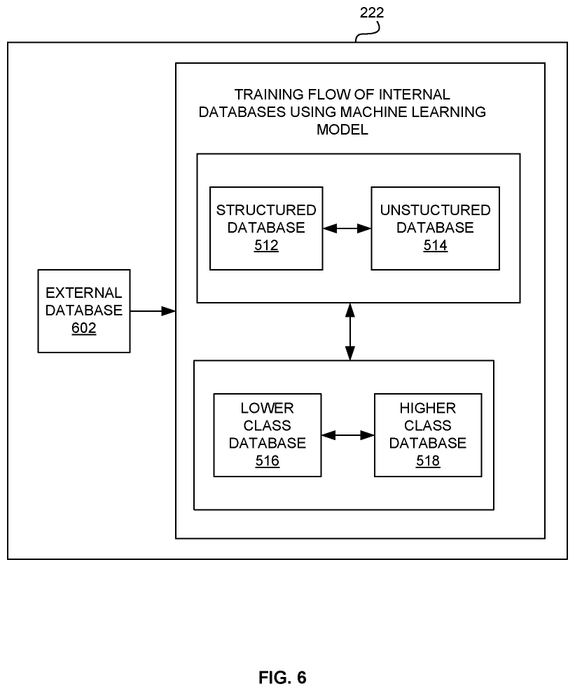

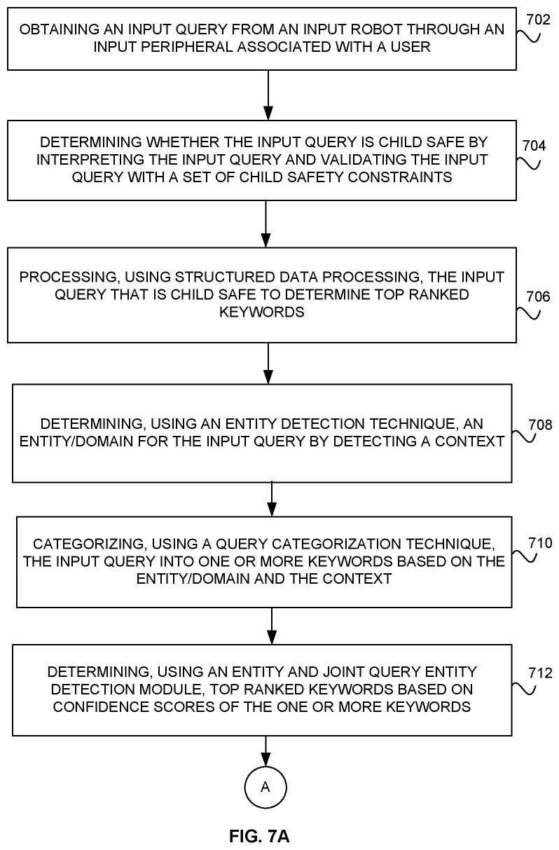

FIG. 6 is an exemplary view of the training flow of the data storage systems 512, 514, 516, 518 using the machine learning model 110 according to some embodiments herein. The exemplary view of training flow of the data storage systems 512, 514, 516, 518 using the machine learning model 110 includes the structured database 512, the unstructured database 514, the lower-class database 516, the higher-class database 518, and an external database 602. In some embodiments, the machine learning model 110 trains the structured database 512 with the unstructured database 514 associated with respective data processing modules. The machine learning model 110 trains the unstructured database 514 with structured database 512 associated with respective data processing modules. The machine learning model 110 trains the lower-class database 516 with the higher-class database 518 associated with respective data processing modules. The machine learning model 110 trains the higher-class database 518 with the lower-class database 516 associated with respective data processing modules. The machine learning model 110 uses the data from external databases to train internal databases if the reaction/response to the input query is not available in any of the above-mentioned internal databases.

FIGS. 7A-7B are flow diagrams that illustrate a method of automatically generating a response for an input query from one or more data storage systems based on a ranking of one or more keywords using a machine learning (ML) model 110 according to some embodiments herein. At step 702, the method includes obtaining an input query from an input robot 104 through an input peripheral associated with a user 102. At step 704, the method includes determining whether the input query is child safe by interpreting the input query, and validating the input query with a set of child safety constraints. At step 706, the method includes processing, the input query that is child safe to determine top-ranked keywords using structured data processing. At step 708, the method includes determining, using an entity detection technique, an entity/domain for the input query by detecting a context. In some embodiments, the entity may not be found, or entity may be invalid, or entity may be found but data may not be found then the recorded fall-back response is sent to the user through the output peripheral of the input robot and the input query is logged into the analytics module to train the machine learning model 110 for self-learning purpose. In some embodiments, the entity may not be found or the entity may be invalid or the entity may be found but data may not be found, then the queries may undergo lower-class unstructured data processing or higher-class structured processing, or higher-class unstructured processing. At step 710, the method includes categorizing, using a query categorization technique, the input query into one or more keywords based on the entity/domain and the context. At step 712, the method includes, determining an appropriate keyword from the top-ranked keywords based on a relevance of an intention of the input query. In some embodiments, query resolution and word sense disambiguation methods are performed by defining the input query such that to match the top-ranked keywords with the intention of the input query less ambiguously. In some embodiments, the entity detection technique, query categorization technique, and an entity and joint query entity detection module are performed concurrently.

At step 714, the method includes determining, using a query resolution technique and a word sense disambiguation method, an appropriate keyword from the top-ranked keywords based on a relevance of an intention of the input query. In some embodiments, the query resolution and word sense disambiguation method are performed by defining the input query such that to match the top-ranked keywords with the intention of the input query less ambiguously. At step 716, the method includes enabling an interactive conversation between the user and the input robot that matches the intention of the user by determining and generating, using a trained ML model, the response for the input query based on the appropriate keyword from the data storage systems and transmitting, the response for the input query to an output peripheral of the input robot.

In some embodiments, the input query can be in any language. In some embodiments, the input queries may be in a user language that is different from the base language, is translated to a base language, and fed to self-learning server 108 and databases in user languages. Similarly, the reaction/responses obtained are translated to the user language. Such systems reduce computational time and improve accuracy for multiple languages over a short period of time.

In some embodiments, while performing a method of processing of the input query for non-real-time higher-class high accuracy data, if the keywords from the input query are not categorized then the query is reviewed manually by the admin present at the backend. In some embodiments, if the entity/domain of categorized keywords may not be detected, then the keywords are reviewed manually for entity/domain detection.

In some embodiments, if the response for the input query may not be found in the unstructured database, then the query is sent to the backend admin where the query is reviewed and answered manually.

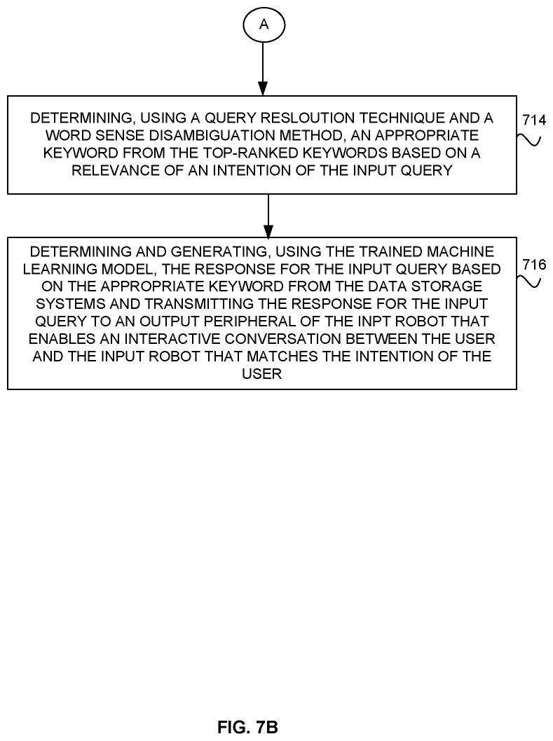

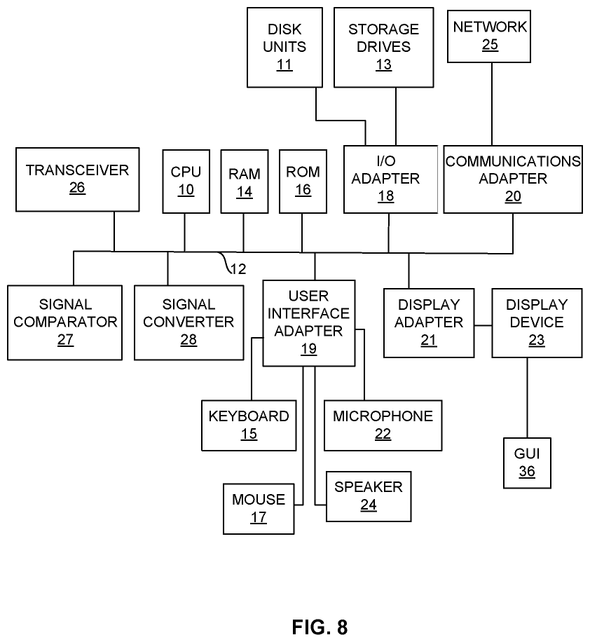

A representative hardware environment for practicing the embodiments herein is depicted in FIG. 8, with reference to FIGS. 1 through 7A and 7B. This schematic drawing illustrates a hardware configuration of a self-learning server 108/computer system/computing device in accordance with the embodiments herein. The system includes at least one processing device CPU 10 that may be interconnected via system bus 15 to various devices such as a random-access memory (RAM) 12, read-only memory (ROM) 16, and an input/output (I/O) adapter 18. The I/O adapter 18 can connect to peripheral devices, such as disk units 58 and program storage devices 50 that are readable by the system. The system can read the inventive instructions on the program storage devices 50 and follow these instructions to execute the methodology of the embodiments herein. The system further includes a user interface adapter 22 that connects a keyboard 28, mouse 50, speaker 52, microphone 55, and/or other user interface devices such as a touch screen device (not shown) to the bus 15 to gather user input. Additionally, a communication adapter 20 connects the bus 15 to a data processing network 52, and a display adapter 25 connects the bus 15 to a display device 26, which provides a graphical user interface (GUI) 56 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for automatically generating a response for an input query from a plurality of data storage systems based on ranking of a plurality of keywords using a machine learning (ML) model, the method comprising:
obtaining the input query from an input robot through an input peripheral associated with a user;
determining whether the input query is child safe by interpreting the input query, and validating the input query with a set of child safety constraints;
processing, using structured data processing, the input query that is child safe to determine top ranked keywords, wherein the top ranked keywords are determined by,
determining, using an entity detection technique, an entity/domain for the input query by detecting a context of the input query;
categorizing, using a query categorization technique, the input query into a plurality of keywords based on the entity/domain and the context;
determining, using an entity and joint query entity detection technique, the top-ranked keywords using confidence scores of the plurality of keywords, wherein the confidence scores of the plurality of keywords are determined using speech recognition alternative methods;
characterized in that,
determining, using a query resolution technique and a word sense disambiguation method, an appropriate keyword from the top-ranked keywords based on a relevance of an intention of the input query, wherein the query resolution technique and the word sense disambiguation method are performed by defining the input query such that to match with the intention of the input query less ambiguously; and
enabling an interactive conversation between the user and the input robot that matches the intention of the user by,
determining and generating, using a trained ML model, the response for the input query based on the appropriate keyword from the data storage systems; and
transmitting, the response for the input query to an output peripheral of the input robot.

2. The processor-implemented method of claim 1, wherein the set of child safe constraints are stored in the data storage systems.

3. The processor-implemented method of claim 1, wherein the method comprises
verifying, using a lower-class structured data processing technique, the response with the set of child safety constraints before transmitting the response for the input query to the output peripheral of the input robot, wherein if the response matches with the set of child safety constraints then the response is child safe and if the response does not match with the set of child safety constraints then the response is not child safe.

4. The processor-implemented method of claim 1, wherein the method comprises, training the ML model by correlating a set of historical input queries with a set of historical responses to obtain the trained ML model.

5. The processor-implemented method of claim 1, the method comprises retraining the ML model if there is a misalignment between the response and a predicted response for the input query by providing the response to the ML model.

6. The processor-implemented method of claim 1, the method further comprises classifying the input query to retrain the ML model if the input query does not satisfy the set of child safety constraints.

7. The processor-implemented method of claim 1, the method further comprises classifying the input query to retrain the ML model if the input query does not have a domain and does not categorize into the plurality of keywords.

8. The processor-implemented method of claim 1, the method further comprises converting an unstructured input query into a structured query by dividing the unstructured input query into at least one paragraphs or sentences to detect a sentence with the structured query, wherein the structured query comprises the input query.

9. The processor-implemented method of claim 1, wherein the structured data processing comprises entity detection technique, query categorization technique, joint entity detection technique.

10. A multi-echelon system for automatically generating a response for an input query based on ranking of a plurality of output keywords received from a plurality of data storage systems using a machine learning (ML) model, the system comprising:
an input robot that is associated with a user comprises at least one of an input peripheral or an output peripheral obtains the input query from the user;
a self-learning server, acquire the input query from the input robot and process the input query using the machine learning model comprises,
a memory unit that stores a database and a set of modules;
a processor that is configured to execute the set of instructions and is configured to characterized in that,
determine whether the input query is child safe by interpreting the input query, and validating the input query with a set of child safety constraints;
process, using structured data processing, the input query that is child safe to determine top ranked keywords, wherein the determination of the top ranked keywords comprises,
determine, using an entity detection technique, an entity/domain for the child safe input query by detecting a context of the input query;
categorize, using a query categorization technique, the input query into a plurality of keywords based on the entity/domain and the context;
determine, using an entity and joint query entity detection module, top ranked keywords based on confidence scores of the plurality of keywords, wherein the confidence scores of the plurality of keywords are determined using speech recognition alternative methods; characterized in that,
determine, using a query resolution technique and a word sense disambiguation method, an appropriate keyword from the top-ranked keywords based on a relevance of an intention of the input query, wherein the query resolution technique and the word sense disambiguation method are performed by defining the input query such that to match with the intention of the input query less ambiguously; and
enable an interactive conversation between the user and the input robot that matches the intention of the user by determining and generating using a trained ML model, the response for the input query from the data storage systems and transmit, the response for the input query to an output peripheral of the input robot.

11. One or more non-transitory computer-readable storage medium storing the one or more sequence of instructions, which when executed by the one or more processors, causes to perform a method for automatically generating a response for an input query from a plurality of data storage systems based on ranking of a plurality of keywords using a machine learning (ML) model, the method comprising:
obtaining the input query from an input robot through an input peripheral associated with a user;
determining whether the input query is child safe by interpreting the input query, and validating the input query with a set of child safety constraints;
processing, using structured data processing, the input query that is child safe to determine top ranked keywords, wherein the top ranked keywords are determined by,
determining, using an entity detection technique, an entity/domain for the input query by detecting a context of the input query;
categorizing, using a query categorization technique, the input query into a plurality of keywords based on the entity/domain and the context;
determining, using an entity and joint query entity detection technique, the top ranked keywords using confidence scores of the plurality of keywords, wherein the confidence scores of the plurality of keywords are determined using speech recognition alternative methods;
characterized in that,
determining, using a query resolution technique and a word sense disambiguation method, an appropriate keyword from the top-ranked keywords based on a relevance of an intention of the input query, wherein the query resolution technique and the word sense disambiguation method are performed by defining the input query such that to match with the intention of the input query less ambiguously; and
enabling an interactive conversation between the user and the input robot that matches the intention of the user by,
determining and generating, using a trained ML model, the response for the input query based on the appropriate keyword from the data storage systems; and
transmitting, the response for the input query to an output peripheral of the input robot.

12. The multi-echelon system of claim 10, wherein the set of child safe constraints are stored in the data storage systems.

13. The multi-echelon system of claim 10, wherein the system comprises
verifying, using a lower-class structured data processing technique, the response with the set of child safety constraints before transmitting the response for the input query to the output peripheral of the input robot, wherein if the response matches with the set of child safety constraints then the response is child safe and if the response does not match with the set of child safety constraints then the response is not child safe.

14. The multi-echelon system of claim 10, wherein the method comprises, training the ML model by correlating a set of historical input queries with a set of historical responses to obtain the trained ML model.

15. The multi-echelon system of claim 10, the method comprises retraining the ML model if there is a misalignment between the response and a predicted response for the input query by providing the response to the ML model.

16. The multi-echelon system of claim 10, the method further comprises classifying the input query to retrain the ML model if the input query does not satisfy the set of child safety constraints.

17. The multi-echelon system of claim 10, the method further comprises classifying the input query to retrain the ML model if the input query does not have a domain and does not categorize into the plurality of keywords.

18. The multi-echelon system of claim 10, the method further comprises converting an unstructured input query into a structured query by dividing the unstructured input query into at least one paragraphs or sentences to detect a sentence with the structured query, wherein the structured query comprises the input query.

19. The multi-echelon system of claim 10, wherein the structured data processing comprises entity detection technique, query categorization technique, joint entity detection technique.
